(19) United States
(12) Patent Application Publication
(10) Pub. No.: US 2002/0018474 A1
(43) Pub. Date: Feb. 14, 2002

(54) Efficient packet transmission over ATM

(75) Inventors: Eyal Assa, Hod Hasharon (IL); David Berechya, Tel Mond (IL)

Correspondence Address: FITCH EVEN TABIN AND FLANNERY, 120 SOUTH LA SALLE STREET, SUITE 1600, CHICAGO, IL, 606033406

(73) Assignee: Seabridge Ltd.

(21) Appl. No.: 09/871,577

(22) Filed: May 31, 2001

Related U.S. Application Data
(60) Provisional application No. 60/208,787, filed on Jun. 1, 2000.

(51) Int. Cl. H04L 12/28; H04L 12/56

(52) U.S. Cl. 370/395.71; 370/412; 370/428; 370/229

(57) ABSTRACT

A method, and apparatus, that enables high throughput of complete packets, transmitted under a packet switching protocol, such as the Internet Protocol (IP), over an ATM node. It is based on buffer threshold management, rather than on tracking individual Virtual Channels (VC). The method is particularly useful for cases in which data cells are routed according to their virtual path (VP).

The basic principle of the method is to ensure that while accepting input data, the buffer has enough available capacity to store complete frames of as many VCs as possible and that, conversely, as long as the buffer's available capacity falls short of such a condition, all incoming data are discarded.

This patent application claims the benefit of U.S. Provisional Application No. 60/208,787, filed Jun. 1, 2000.

### FIELD OF THE INVENTION

This invention relates to transmission of data packets over ATM networks and, in particular, to efficient transmission of complete packets through an ATM node.

### BACKGROUND OF THE INVENTION

A prevalent method of data communication is that of packet switching, as realized, for example under the widely used Internet Protocol (IP).

A packet may have various lengths—from 40 to 64K bytes—and contains data and a header part that is used for routing information, error detection and for other administrative information. Under most of the protocols for communication over packet-switching systems, such as the IP protocol, only complete packets can be processed by a receiver; incompletely received packets are discarded and their retransmission is requested.

Packets may be transmitted over any unspecified route, which route may include any of a variety of transmission networks. One common type of such a network is a so-called Asynchronous Transfer Mode (ATM) network

In an ATM network, data are organized into a series of cells, each cell consisting of 53 consecutive bytes of which 48 bytes carry information and a five bytes header contains routing information. Each data cell is identified as belonging to a particular Virtual Channel (VC), which represents a virtual communication link between the source of the data and its destination. Each VC is routed through the network from a source node (SN), through certain intermediate nodes and transmission links that interconnect them, to a destination node (DN). Over any of these links there are generally transmitted a plurality of VCs. All the cells of any particular VC carry in their headers a corresponding VC indicator (VCI). Each header also includes a Mutual Path (VP) indicator (VPI), which may be in common with other VCs, but any particular combination of VPI and VCI over any port is unique. All VCs that share a path from one certain node to another may be, and usually are, identified as belonging to a particular VP and thus their headers carry an identical VPI. Over each link, cells of various VCs are transmitted in an interleaved fashion, whereby cells belonging to any one VC are transmitted in sequence (though not necessarily successively).

At an ATM node, partly illustrated in FIG. 3, data received from linked nodes over respective input paths 26 are first switched, by means of switch 24, into appropriate output paths 28; upon reception, the header of each individual cell is examined for its VPI- and possibly also VCI code and the cell is switched according to routing information provided by the system control. Depending on system setup, at certain nodes, cells belonging to certain VPs over certain ports are all routed in common and there is no routing information provided for individual VCs. The routing of each such cell is determined solely according to its VPI. For other VPs, or, at certain other nodes, for all VPs, the routing information is provided for each VC and thus the routing of each cell is determined according to its VCI as well as its VPI.

All cells routed to any one output path, such as path 27, are typically stored in a respective FIFO-type buffer 20, from which they are sent on to the corresponding output port 22 (through which they are sent on, over an appropriate link, to the corresponding node). The purpose of the buffer is to absorb bursts of cells, that is to store excess cells that arrive during periods in which the combined rate of input streams, routed to the respective output path 27, is higher than the combined output transmission rate (e.g. through output port 22). The size of the buffer allocatable to any path is finite and if a period of excessive input rate is too long, the buffer may become full and then some of the arriving cells must be discarded.

It is noted that the above processes describe the typical operation of a router or a switching unit at the node. Other types of data transmission equipment may also be found at a node or at any end terminal of an ATM network, to at least some of which the present invention may be applicable, as well. All such equipment units will be commonly referred to, as “ATM platforms” and the term “node” will be understood to include network terminals.

When packets according to a packet-switching protocol (such as IP) are conveyed over an ATM network, each packet 12 (FIG. 1) is reassembled into consecutive data cells 14, whereby a group of consecutive cells that correspond to one packet are called a Frame and the last cell 16 of a frame, is marked as EOF (End Of Frame); in FIG. 1, the EOF cell 16 is marked by a bold box A stream of consecutive packets to be routed from a particular input port of the ATM network to a particular output port is reassembled into a stream of corresponding frames, whereby their sequence is preserved, as illustrated schematically in FIG. 2a (where each letter denotes a frame or packet and each numeral—a cell within the frame—all in their proper sequence). Such a stream of frames is identified as a virtual channel (VC) and all cells thereof are given the corresponding VCI code.

Similarly to other ATM traffic, also when carrying packet data, various VCs may be bundled into a common virtual path (VP) and given a corresponding VPI code. This may occur, for example, at any output path in an ATM node, after switching into it the appropriate VCs (as explained above). Again, cells belonging to any VC are transmitted sequentially, whereby cells of various VCs are randomly interleaved, for example as illustrated schematically in FIG. 2b. Here, cells X1, X2, X3, X4 belong to a certain frame of VC X, while Y1, Y2 belong to a concurrent frame of VC Y and so on (whereby, again, EOF cells are marked by bold boxes). It is noted that the cells of any one VC remain in their proper sequence. This is, then, the structure of a stream of cells that arrives at an output buffer, such as buffer 20 (FIG. 3).

As mentioned above, under common protocols, such as IP, incomplete packets are useless. In case of transmission over an ATM node, it is thus sufficient that any cell of a frame fails to go through, e.g. is discarded at any node owing to a full buffer, for the entire corresponding packet to become useless. FIG. 4a illustrates an example of a situation that may arise at a conventional output buffer of a typical ATM node during a burst of input data. In this example, which is extremely simple for the sake of illustration, cells that carry two streams of packets, each packet carried by two successive cells, arrive at the buffer at an input rate that is twice the output rate. After a certain period the buffer becomes full and from this point on, every second cell will be discarded and will not enter the output stream from die buffer. Now, if successive cells were arranged exactly so that, over a certain period, every second cell belongs to a particular frame, and therefore to a corresponding one packet, then this packet would be transmitted complete; at the same time, all the odd cells, which will be discarded belong to the packet from the other stream, which would have been rejected even after the loss of the first cell. In this hypothetical case, packet transmission is said to be 100% efficient, i.e. the entire output bandwidth is used to carry complete packets only. In real systems, such as illustrated in FIG. 4a, the occurrence of such an ideal interleaving of packets over successive cells is statistically very improbable, all the more so—when the number of packet streams is much more than two. It will then rather be highly probable that cells carrying data of many different packets, possibly even of all current ones, will be discarded and thus most packets, possibly even all current ones, will be transmitted incomplete. Packet transmission under such and similar circumstances is thus generally very inefficient, i.e. the proportion of data belonging to complete packets within the output stream is very low (compared to the 100% in the hypothetical case discussed above).

There is a well-known prior-art method for increasing the efficiency of packet transmission through ATM nodes, known as EPD/PPD (Early Packet Drop/Partial Packet Drop). According to this method, if any cell belonging to a certain packet were discarded because of buffer congestion (or any other reason), the rest of the cells belonging to the same packet will also be discarded, since they will be useless. In other words, the method calls for a filtering mechanism that examines each arriving cell and blocks its entrance if it belongs to a packet that has already been determined as being incomplete, thus freeing the buffer to accept only cells of complete packets. According to the PPD method, the last cell of any frame (which cell is marked as EOF and contains the corresponding packet's trailer) is accepted, including frames determined to be incomplete; this is sometimes done in order to enable the receiver to identify the boundary of the defective packets.

One drawback of the EPD/PPD method is that there must be a record kept at the node, regarding possible frame incompleteness, for each VC routed through the node, which requires a state machine per VC In relatively central nodes, the number of VCs can be very large (up to 65536 per VP, which number, moreover, is not always known); this makes a per-VC state-machine very complicated to handle and is often beyond the capabilities of typical node switching equipment. Another drawback of the EPD/PPD method is that it totally fails in the cases of routing by VP, since there is then no information available about the individual VCs—e.g. lengths of packets. Moreover, in some cases a VP may contain some VCs that do not convey packets at all, thus possibly lacking end-of-frame cells and causing the method to break down.

There is thus a clear need for a simple and efficient data buffering technique in an ATM node that caries packets communication, which will result in a high throughput of complete packets, while using considerably less computer resources than do prior-art methods and will be effective also in case of VP switching.

### SUMMARY OF THE INVENTION

The invention disclosed herein is of a method, and corresponding apparatus, that enables high throughput of complete packets, transmitted under a packet switching protocol, such as (but not limited to) the Internet Protocol (IP), over an ATM node. It is based on buffer threshold management, rather than on tracking individual VCs. The method is particularly useful for packet switching communication protocols that require the reception of complete packets only, such as IP.

The basic principle of the method is to ensure that while accepting input data, the buffer has enough available capacity to store complete frames of as many virtual channels (VCs) as possible and that, conversely, as long as the Buffer's available capacity falls short of such a condition, all incoming data are discarded.

FIG. 4b illustrates the possible results of applying this principle for the simple exemplary scenario that was illustrated by FIG. 4a with respect to a conventional buffer (as discussed in the Background section). In this exemplary case, the buffer, operating under the principles of the invention, allows storing, say, the first complete packet, X1-X2, then, while waiting for a similar amount of data to be transmitted, it possibly discards the next complete packet, Y1-Y2, (rather than just the next cell, as is done in the case of a conventional buffer). The result then is that complete packets are transmitted at, or near, half the combined input rate (i.e. at the full output rate)—which is equivalent to high possibly 100%, packet efficiency.

This principle is preferably (but not exclusively) embodied by providing the buffer with a so-called hysteresis threshold level, in addition to the maximum threshold level. Whenever the buffer is filled up to the maximum level it enters a Blocking State, during which any incoming data cells are discarded. Whenever the buffer is emptied down to below its hysteresis level, it switches to an Absorbing State, during which all incoming cells are accepted for storage. The cycle of switching between the two states repeats as long as the incoming rate exceeds the outgoing rate. The hysteresis threshold level may have any desired value tat is substantially lower than the full buffer level by an amount that may be determined for each output buffer on the basis of the number of VCs routed over it, the capacities of input- and output links and other system variables.

Specifically, there is provided for an Asynchronous Transfer Mode (ATM) network of nodes operative to transmit data according to a packet communication protocol, whereby the data includes packets and each packet is transmitted as a series of data cells, the network including, at one or more nodes, at least one buffer for storing data cells routed to them and designated to be transmitted from the node

a traffic management method, comprising, with respect to any of the buffers:

(i) causing the buffer, while in an absorbing state, to receive and store any cell routed to it and, further, when the buffer's fill level reaches a maximum level, to switch to a blocking state; and

(ii) causing the buffer, while in the blocking state, to refrain from receiving and storing any cell and, further, when the buffer's fill level falls below a hysteresis level, to switch to the absorbing state.

In another aspect of the invention, there is provided in an Asynchronous Transfer Mode (ATM) node equipment, having at least one output port and a buffer associated with each output port the node being operative to transmit a plurality of input packet streams, according to a packet communication protocol, to any of the buffers, whereby each packet is transmitted as a series of data cells, cells corresponding to different packet streams being mutually interleaved

a traffic management method, comprising, with respect to any of the buffers, the steps of:

(i) ensuring that, while accepting input cells, the buffer has enough available capacity to store data of complete packets belonging to a substantial proportion of the input streams; and

(ii) discarding all input cells as long as the buffer's available capacity falls short of enabling step (i).

There is also provided, according to the invention, a platform within an ATM node comprising at least one buffer operative to perform the steps of the methods disclosed above. Similarly them is provided an ATM network that includes one or more nodes comprising at least one buffer operative to perform the steps of the methods disclosed above. Likewise there is provided a program storage device readable by machine, tangibly embodying a program of instructions executable by the machine to perform the steps of the methods disclosed above.

In yet another aspect of the invention, there is provided An Asynchronous Transfer Mode (ATM) platform, having at least one output port and being operative to transmit data according to a packet communication protocol; the data includes packets and each packet is transmitted as a series of data cells, each cell including a Virtual Path Indicator (VPI) and being routable to any of the output ports, at least some of the cells being routable according to their respective VPIs only; and

the ATM platform is further operative to manage the flow of cells to at least one of the output ports, it being a managed port, so tat, over any period of time during which the number of cells routed to the port exceeds the number of cells transmittable therefrom, the proportion of complete packets transmitted is substantially greater than if the flow were not thus managed.

### BRIEF DESCRIPTION OF THE DRAWINGS

In order to understand the invention and to see how it may be carried out in practice, a preferred embodiment will now be described by way of non-limiting example only, with reference to the accompanying drawings, in which:

FIG. 1 is a schematic illustration of the relation between a packet and AIM cells.

FIGS. 2a and 2b are schematic illustrations of the structure of packets in a stream of ATM cells within a virtual channel VC and that of several VCs combined within a virtual path, respectively.

FIG. 3 is a partial block diagram of an ATM communication node, showing a buffer in an output path.

FIGS. 4a and 4b are schematic illustrations of buffer input- and output data streams, showing different efficiencies in transmission of complete packets over ATM according to the invention in comparison to prior art.

FIG. 5 is a schematic illustration of the buffer thresholds structure according to the invention.

FIG. 6 is a flow chat of the preferred method of the invention.

FIG. 7 is a schematic illustration of an example of inefficiency in packet transmission over ATM caused by acceptance of EOF cells.

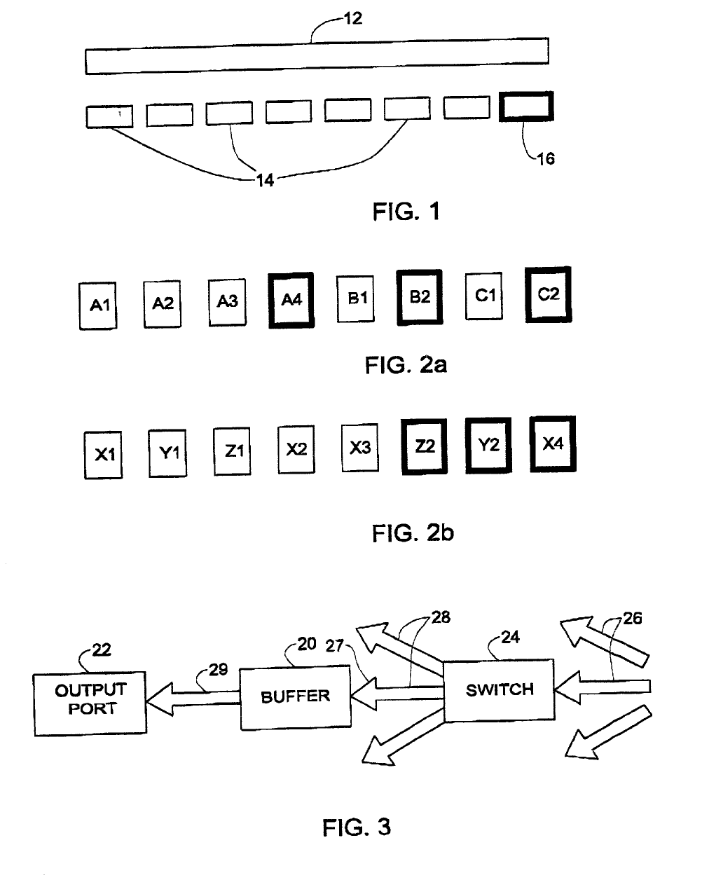

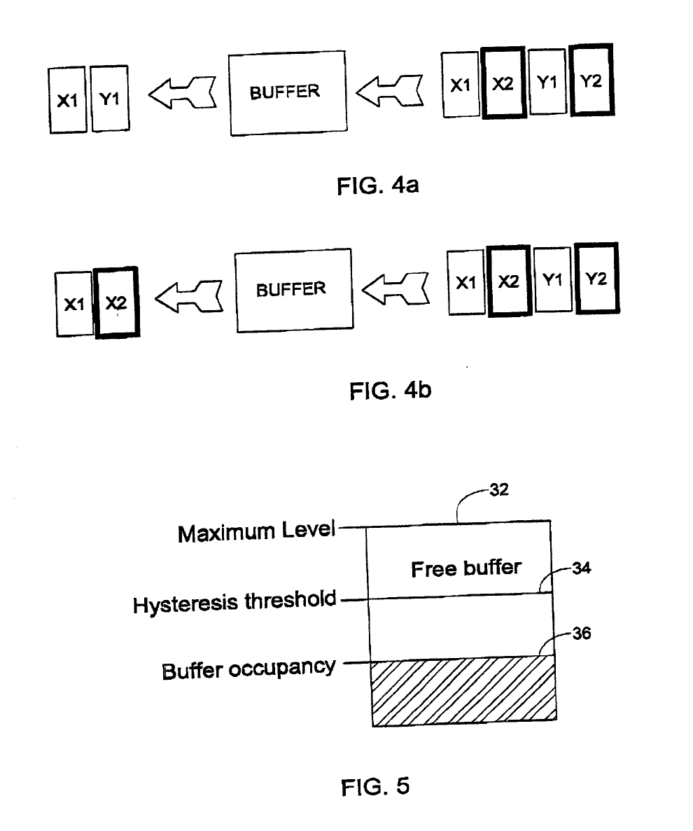

### DETAILED DESCRIPTION OF THE INVENTION

FIG. 5 shows schematically an output buffer structure in an ATM node that is used, according to the invention, to achieve high throughput of complete packets. There are marked two thresholds levels at respective levels of buffer filling: At the upper level, which corresponds to the allocated size of the buffer and is preferably close to it, is the so-called Maximum Level 32. At the lower level, corresponding for example to 50% of the Maximum Level, theme is a so-called Hysteresis Level 34, whose function will be explained below. It is noted that the two threshold levels shown in FIG. 5 serve only as examples and that they may generally have any value, depending on the circumstances.

There are also defined, with respect to the buffer's operation, two complementary (i.e. mutually exclusive) states, namely an “Absorbing State” and a “Blocking State”. While the buffer is in the Absorbing State, all data cells arriving over the combined input path are written into the buffer. Conversely, while the buffer is in the Blocking State, all data cells arriving over the combined input path are prevented from entering the buffer, i.e. are discarded. There is also shown in FIG. 5 a current occupancy level. 36, which is just an exemplary representation of the actual degree of buffer fill at some instant, the filled portion of the buffer being shown as cross-hatched area; the particular level of occupancy shown in this example is below the Hysteresis Level.

The operation of the buffer according to the preferred embodiment is guided by three simple rules:

1. At the beginning, and as long as the fill level is below the Hysteresis Level (which is the normal situation during uncrowded traffic), the buffer is in the Absorbing State

2. The buffer transits from the Absorbing State to the Blocking State when the fill level reaches the Maximum Level.

3. The buffer transits from the Blocking State to the Absorbing State when the fill level falls below the Hysteresis Level.

It is now observed that in a situation corresponding to that prevailing for rule 1, no cells are, or need be, discarded at all and the buffer operates similarly to a conventional buffer. When, however, the buffer occupancy is near the Maximum level, the probability that all cells belonging to any one packet will be absorbable becomes low. Therefore, according to the present invention and in contradistinction to the operational mode of conventional buffers, when the buffer occupancy first reaches the upper threshold, the buffer enters the Blocking State, whereby all new cells are discarded. The buffer occupancy is then allowed to subside by the outputting process until it falls below the Hysteresis Threshold, and only then does the buffer exit the Blocking State and enter the Absorbing State, whereupon the buffer may again absorb new cells. At this level there is a relatively high probability that most, if not all, cells that are now absorbed, until the occupancy level again reaches the top, form complete frames, i.e. carry complete packages.

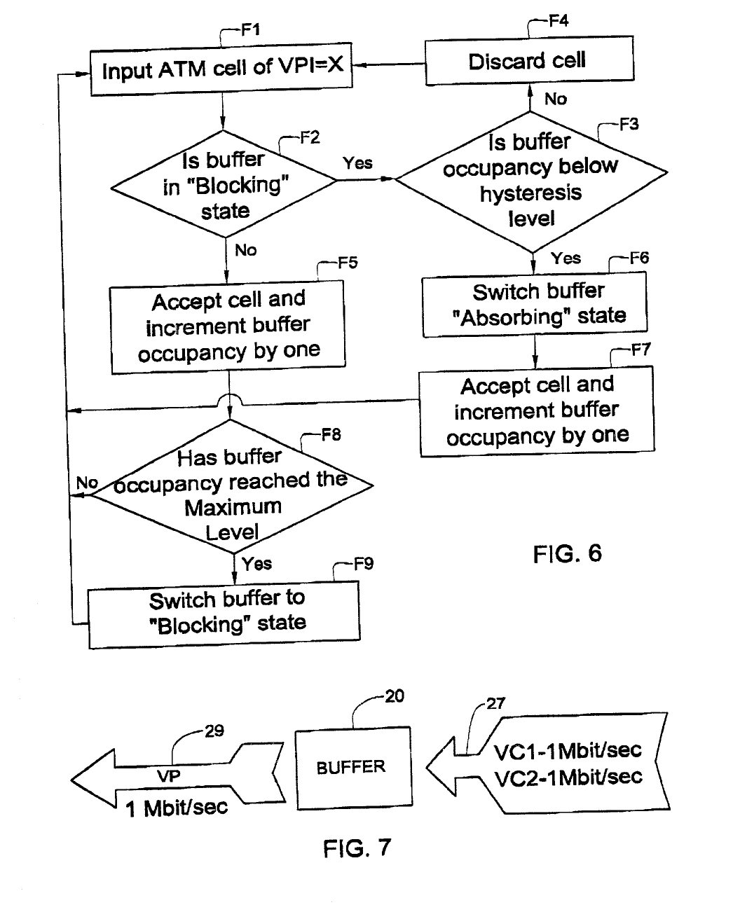

FIG. 6 presents a flow chart of a preferred procedure to carry out the method of the invention. In essence, the algorithm is as follows (with reference to FIG. 6 and its marked functions):

For each cell that arrives at the buffer input (F1) check the state of the buffer (F2);

If the buffer is in the Blocking State, check whether the occupancy level is below the hysteresis threshold (F3);

if not, discard the cell (F4);

if yes, switch to the Absorbing State F6) and accept the cell (F7);

If the buffer is in the Absorbing State, accept the cell (F5) then check whether the buffer occupancy exceeds the Maximum Level (F8);

if yes, switch to the blocking state (F9);

if no, remain in the Absorbing State.

It will be appreciated that the above algorithm is just an example of specific realization of the principles stated above. Thus, the exact conditions for switching from the Absorbing State to the Blocking State may be variously set or stated—all being referred to as the buffer's fill level reaching the Maximum. Level. Similarly, all conditions for switching from the Blocking State to the Absorbing State are referred to as the buffer's fill level failing below the Hysteresis Level.

The value of the Hysteresis threshold level is not critical, but may be variably set for any buffer at any node to optimize the data flow, i.e. statistically maximize the transmission of complete packets. It would preferably be set according to some measure of the rate of total cells traffic, e.g. according to expected statistics of traffic congestion and of average flow rates, and/or according to the number of VPs and VCs routed over the particular path. Optionally, the setting of the Hysteresis threshold level occurs dynamically, following variations in such flow- or routing statistics.

It is noted that the method of the invention causes the proportion of complete packets transmitted to increase substantially, as explained above, thus becoming relatively efficient in packet transmission. This means that over any link of the network that has a given bandwidth (i.e. given maximum transmission rate), there will be a relatively large number of complete packets transmitted, thus minimizing the number of incomplete packets, which according to most common protocols require retransmission. The net result is a substantially higher data throughput than would be possible otherwise. It is further noted that the method of the invention is advantageous over methods of prior ark such as EPD and PPD (described in the Background section above), in that it requires minimal additional computing resources (in contradistinction to EPD/PPD, where a state machine per VC is required), while being about equally efficient in transmitting complete packages. The method of the invention is particularly advantageous for VP switching nodes (which usually are the central nodes of the network) where EPD/PPD methods fail entirely, owing to lack of information re individual VCs, as explained above in the Background section.

It must also be stated that the practice of always absorbing (accepting) EOF cells, as is the case in the PPD procedure, detracts from the efficiency of packet transmission under any method, especially for short packets. This may be demonstrated by means of an extreme example, illustrated in FIG. 7: The situation in this example is that there are two VC streams currently routed into the input path 27 of buffer 20, each at a rate of 1 Mb/s (for a total of 2 Mb/s), while the output path 29 carries 1 Mb/s. Also, in this example, the length of each frame is assumed to be two cells, whereby each second cell carries the EOF. Normally, with efficient buffering, one half of the incoming packets will be absorbed and sent on. However, if absorption of EOF cells is required, the entire transmission bandwidth will be devoted to these cells and not a single complete packet will be transmitted, resulting in zero efficiency. For this reason, the preferred embodiment of the invention precludes forcefully absorbing EOF cells and therefore does not call for examining the headers of incoming cells as to their being EOF cells, thus keeping to the simplicity of the method.

It will also be understood that the system according to the invention may be a suitably programmed computer. Likewise, the invention contemplates a computer program being readable by a computer for executing the method of the invention. The invention flier contemplates a machine-readable memory tangibly embodying a program of instructions executable by the machine for executing the method of the invention.

The present invention has been described with a certain degree of particularity, but those versed in the art will readily appreciate that various alterations and modifications may be carried out without departing from the scope of the following claims.

1. An Asynchronous Transfer Mode (ATM) network of nodes operative to transmit data according to a packet communication protocol; the data includes packets and each packet is transmitted as a series of data cells; at least one of said nodes comprises one or more buffers for storing data cells routed to them and designated to be transmitted from the node; and any of said buffers is operative to perform at least the following
while in an Absorbing State, to receive and store any cell routed to it and, further, when its fill level reaches a maximum level to switch to a blocking state; and
while in said blocking state, to refrain from receiving and storing any cell and, further, when its fill level falls below a hysteresis level, lower than said maximum level, to switch to said absorbing state.

2. The network of claim 1 wherein the packet communication protocol is an Internet Protocol (IP).

3. The network of claim 1 wherein each data cell includes a Virtual Path Indicator (VPI) and wherein, at any node, any data cell is routed according to its VPI only.

4. The network of claim 1 wherein, at any node and for any buffer, said hysteresis level is determined according to some measure of the rate of total cells traffic routed to the buffer.

5. An Asynchronous Transfer Mode (AIM) platform operative to transmit data through an ATM node according to a packet communication protocol; the data includes packets and each packet is transmitted as a series of data cells; the platform comprises at least one buffer for storing data cells routed to it and designated to be transmitted from the node; and any of said buffers is operative to perform at least the following
while in an absorbing state, to receive and store any cell routed to it and, further, when its fill level reaches a maximum level, to switch to a blocking state; and
while in said blocking state, to refrain from receiving and storing any cell and, further, when its fill level falls below a hysteresis level, lower than said maximum level, to switch to said absorbing state.

6. The platform of claim 5 wherein the packet communication protocol is an Internet Protocol (IP).

7. The platform of claim 5 wherein each cell includes a Virtual Path Indicator (VPI) and wherein any cell is routed to any buffer according to its VPI only.

8. The platform of claim 5 wherein, for any buffer, said Hysteresis Level is determined according to some measure of the rate of total cells traffic routed to the buffer.

9. In an Asynchronous Transfer Mode (ATM) network of nodes operative to transmit data according to a packet communication protocol, whereby the data includes packets and each packet is transmitted as a series of data cells, the network including, at one or more nodes, at least one buffer for storing data cells routed to them and designated to be transmitted from the node
a traffic management method, comprising, with respect to any of the buffers:
(i) causing the buffer, while in an absorbing state, to receive and store any cell routed to it and, further, when the buffer's fill level reaches a maximum level, to switch to a blocking state; and
(ii) causing the buffer, while in said blocking state, to refrain from receiving and storing any cell and, further, when the buffer's fill level falls below a hysteresis level, to switch to said absorbing state.

10. The method of claim 9, the packet communication protocol being an Internet Protocol (IP).

11. The method of claim 9, wherein each cell includes a Virtual Path Indicator (VPI), whereby, at any node, any cell is routed according to its VPI only.

12. The method of claim 9 whereby, at any node and for any buffer, said hysteresis level is determined according to some measure of the rate of total cells traffic routed to the buffer.

13. An Asynchronous Transfer Mode (ATM) platform, having at least one output port and being operative to transmit data according to a packet communication protocol; the data includes packets and each packet is transmitted as a series of data cells, each cell including a Virtual Path Indicator (VPI) and being routable to any of the output ports, at least some of the cells being routable according to their respective VPIs only; and
the platform is flier operative to manage the flow of cells to at least one of the output ports, it being a managed port, so that, over any period of time during which the number of cells routed to the port exceeds the number of cells transmittable therefrom, the proportion of complete packets transmitted is substantially greater than if the flow were lot thus managed.

14. Tie platform of claim 13, comprising a buffer, associated with any of said managed ports and serving to store cells designated to be transmitted therefrom, said buffer being operative to perform at least the following
while in an absorbing state, to receive and store any cell routed to it and, further, when its fill level reaches a maximum level, to switch to a blocking state; and
while in said blocking state, to refrain from receiving and storing any cell and, further, when its fill level falls below a hysteresis level, lower than said maximum level, to switch to said absorbing state.

15. The platform of claim 14 whereby said hysteresis level is determined according to some measure of the rate of total cells traffic routed to the buffer.

16. The platform of claim 13 the packet communication protocol being an Internet Protocol (IP).

17. In an Asynchronous Transfer Mode (ATM) node equipment, having at least one output port and a buffer associated with each output port, the node being operative to transmit a plurality of input packet streams, according to a packet communication protocol, to any of the buffers, whereby each packet is transmitted as a series of data cells, cells corresponding to different packet streams being mutually interleaved
traffic management method, comprising, with respect to any of the buffers:
(i) ensuring that, while accepting input cells, the buffer has enough available capacity to store data of complete packets belonging to a substantial proportion of the input streams;
(ii) discarding all input cells as long as the buffer's available capacity falls short of enabling step (i).

18. The method of claim 17,
wherein step (i) includes for the buffer, while in an absorbing state, to receive and store any cell transmitted to it and, further, when its fill level reaches a maximum level, to switch to a blocking state;
and wherein step (ii) includes for the buffer, while in said blocking state, to refrain from receiving and storing any cell and, further, when its fill level falls below a hysteresis level, lower than said maximum level, to switch to said absorbing state.

19. The method of claim 17 wherein the packet communication protocol is an Internet Protocol (IP).

20. The method of claim 17 wherein each data cell includes a Virtual Path Indicator (VPI) and wherein any data cell is routed according to its VPI only.

21. The method of claim 17 wherein, for any buffer, said hysteresis level is determined according to some measure of the rate of total cells traffic routed to the buffer.

22. An Asynchronous Transfer Mode (ATM) node platform having at least one output port and being operative to transmit a plurality of input packet streams, according to a packet communication protocol, to any of the ports, whereby each packet is transmitted as a series of data cells, cells corresponding to different packet streams being mutually interleaved, the platform comprising a buffer, associated with any of the output ports and being operative to accept input cells only while having enough available capacity to store data of complete packets belonging to a substantial number of input streams and to discard input cells otherwise.

23. The ATM platform of claim 22, wherein said buffer is further operative to perform at least the following
while in an absorbing state, to receive and store any cell routed to it and, further, when its fill level reaches a maximum level, to switch to a blocking state; and
while in said blocking state, to refrain from receiving and storing any cell and, further, when its fill level falls below a hysteresis level, lower than said maximum level, to switch to said absorbing state.

24. The platform of claim 22 wherein said hysteresis level is determined according to some measure of the rate of total cells traffic transmitted to said buffer.

25. The platform of claim 22 the packet communication protocol being an Internet Protocol (IP).

26. The platform of claim 22 wherein each data cell includes a Virtual Path Indicator (VPI) and wherein any data cell is routed according to its VPI only.

27. In an Asynchronous Transfer Mode (ATM) network of nodes operative to transmit data according to a packet communication protocol, whereby the data includes packets and each packet is transmitted as a series of data cells, the network including, at one or more nodes, at least one buffer for storing data cells routed to them and designated to be transmitted from the node
a traffic management program storage device readable by machine, tangibly embodying a program of instructions executable by the machine to perform method steps, comprising, with respect to any of the buffers:
(i) causing the buffer, while in an absorbing state, to receive and store any cell routed to it and, further, when the buffer's fill level reaches a maximum level, to switch to a blocking state; and
(ii) causing the buffer, while in said blocking state, to refrain from receiving and storing any cell and, her, when the buffer's fill level falls below a hysteresis level, to switch to said absorbing state.

28. In an Asynchronous Transfer Mode (ATM) network of nodes operative to transmit data according to a packet communication protocol, whereby the data includes packets and each packet is transmitted as a series of data cells, the network including, at one or more nodes, at least one buffer for storing data cells routed to them and designated to be transmitted from the node
a traffic management computer program product comprising a computer useable medium having computer readable program code embodied therein, the computer program product comprising:
computer readable program code for causing the computer to cause the buffer, while in an absorbing state, to receive and store any cell routed to it and, further, when the buffer's fill level reaches a maximum level, to switch to a blocking state; and
computer readable program code for causing the computer to cause the buffer, while in said blocking state, to refrain from receiving and storing any cell and, further, when the buffer's fill level falls below a hysteresis level, to switch to said absorbing state.
